(19) United States
(12) Patent Application Publication
(10) Pub. No.: US 2006/0117655 A1
(43) Pub. Date: Jun. 8, 2006

(54) Agglomerated volcanic ash

(76) Inventors: Frederick M. Bodycomb, Springfield, CO (US); Charles S. Smith, Hudson, OH (US)

Correspondence Address: Timothy B. Smith, Suite 1300, 185 South State Street, Salt Lake City, UT, 84111, US

(21) Appl. No.: 11/060,114

(22) Filed: Feb. 16, 2005

Related U.S. Application Data
(63) Continuation-in-part of application No. 11/003,800, filed on Dec. 2, 2004.

(51) Int. Cl. A01G 31/00

(52) U.S. Cl. 47/59 S

(57) ABSTRACT

Volcanic ash, which becomes airborne during a volcanic eruption, can be deposited more than a thousand miles from the eruption site. Currently, many volcanic ash deposits are virtually unused. The method and product of the present invention converts this unused volcanic ash material, as well as furnace expanded volcanic ash, or the ash expanded and crushed, into a relatively dust free product with numerous new end applications.

### RELATED APPLICATION

This application is a continuation-in-part of Ser. No. 11/003800 filed Dec. 2, 2004, now pending, by the inventors hereof, under the title “Product for and Method of Aerial Seeding Using Agglomerated Minerals,” where the contents thereof are incorporated herein in their entirety.

### FIELD OF THE INVENTION

The present invention relates to volcanic ash ore, and both furnace expanded, and furnace expanded/crushed volcanic ash; methods of agglomeration; and uses of these volcanic ash materials.

### BACKGROUND OF THE INVENTION

Volcanic ash (also referred to as pumicite) is a fine grained, essentially unconsolidated glassy material that originates from the eruption of volcanoes. The ash becomes airborne and can be deposited many miles from the eruption site. In fact, in some cases, volcanic ash is deposited more than a thousand miles from the eruption site.

While a number of volcanic ash deposits located in the Midwestern United States were commercially exploited in the past, those operations did not last long, and currently only two deposits are known to be in commercial operation. The primary drawbacks to using volcanic ash, unexpanded or expanded, for many applications, as compared to other volcanic minerals like perlite, is its inherently small particle ore size, typically 75%<200 mesh, and the resulting dustiness. As a consequence, some literature refers to volcanic ash as “volcanic dust.”

Historically, volcanic ash ore has been used as an abrasive in hand soap or as a pozzolan in portland cement. Minor uses have included road construction, and in cosmetics, glass, and ceramics. Also, volcanic ash ore from a deposit in Jewell County, Kansas is presently furnace expanded, crushed, and used as a filter aid. However, the uses of volcanic ash, both ore and expanded, have been relatively limited. Volcanic ash, although plentiful in the United States, is a remarkably underutilized mineral.

Because volcanic ash ore particles are so small and the material is so powdery, commercial concerns have not taken full advantage of the positive characteristics of volcanic ash. For example, furnace expanded volcanic ash has very good water absorption and retention, and thermal and acoustic characteristics. Nevertheless, volcanic ash has not been used in any of those applications.

There is a need for material that possesses the various characteristics of volcanic ash, unexpanded and expanded, including but not limited to water retention and thermal and acoustic insulation. Accordingly, massive amounts of currently unusable volcanic ash deposited in the United States and the world may be more fully utilized if converted to a physical form with larger particle size and reduced dustiness.

### SUMMARY OF THE INVENTION

The present invention provides a solution to existing needs as well as many others. By agglomerating volcanic ash ore, as well as furnace expanded volcanic ash, new products are created. This is of particular use in converting fine expanded volcanic ash into valuable, large-particle horticultural grades. In other words, volcanic ash can be made into many other useful products.

For horticultural/agricultural uses, expanded and agglomerated volcanic ash holds and absorbs water, increasing the moisture holding capacity of the soil, reducing the rate of evaporation, and enhancing the retention of moisture in the soil, which in turn makes additional water available to plants over an extended period of time. Additionally, expanded and agglomerated volcanic ash can be used as a carrier for seeds, fertilizer, insecticides, pesticides, herbicides, rodenticides, fungicides, and germination promoters, initiators and enhancers such as butenolides, etc., which can be easily added during the agglomeration process. Low-density forms of expanded and agglomerated volcanic ash can also be used to loosen impermeable, generally clayey soils. Horticultural/agricultural grades of expanded and agglomerated volcanic ash would be sold in markets in which perlite and vermiculite currently dominate. It could be used in applications ranging from potting soil and individual home and garden use, to high value crops like flowers and vegetables, and other commercially grown crops.

Expanded and agglomerated volcanic ash can also be used as a relatively dust-free thermal and/or acoustical insulator, especially when agglomerated with a binder such as sodium silicate or other alkaline metal silicate. One such use is for “cavity fill” insulation in such areas as between joists in attics and between studs in walls, and in masonry cavities. Expanded and agglomerated dust-free volcanic ash in granular or pellet form would be ideal for such applications. The incorporation of a fungicide in the agglomerates would also inhibit the growth of molds. A second new use would be for cryogenic insulation. Expanded and agglomerated volcanic ash would not settle in the cavity of a container or vessel to the extent that loose, small-particle materials that are currently in use settle.

Another use for expanded and agglomerated volcanic ash is for aerial reseeding of fire-burned or otherwise denuded areas. Present reseeding in slurry or dry seed form are susceptible to blowing from wind and have other serious drawbacks. Use of seeds, fertilizer, insecticides, pesticides, herbicides, rodenticides, fungicides, and germination promoters, initiators and enhancers such as butenolides etc. agglomerated with expanded volcanic ash in a pellet form allows for more accurate placement from an aircraft, permits reseeding to proceed in windier conditions, and has numerous other benefits.

New uses or increased usage for volcanic ash, which is not expanded, also are possible with agglomerated material. Traditional uses such as abrasives in soaps, etc. might find greater usage if the purchaser received the material in a relatively dust-free pellet form which disintegrated and dispersed with gentle mixing.

A further new use for unexpanded, agglomerated volcanic ash may be as a silica source in calcium silicate insulations, boards, and other calcium silicate uses, such as acetylene cylinder filler material. Pellet forms would make shipment and handling relatively dust-free. After dispersion in the aqueous slurry, the fine particle size would be desirable for rapid reaction with the highly alkaline lime slurry.

A further new use for agglomerated volcanic ash is for filtration. A possible advantage might be gained for certain filtration processes, with volcanic ash agglomerated after expansion and crushing. The agglomerated form results in relatively dust-free handling. Disintegration and dispersion in the liquid to be filtered provides filtration characteristics equivalent to the loose, dusty form of volcanic ash.

The potential use of volcanic ash (ore, expanded, or expanded and crushed) in agglomerated form for asphalt fillers is potentially large. For asphalt paving, ore agglomerates can be added to the hot mix to provide needed fine material in a manner that allows relatively dust-free handling. The volcanic ash would also act as friction particles, increasing the skid resistance of the pavement.

Other filler applications for volcanic ash in any form (ore, expanded, or expanded and crushed) are for caulks, mastics, plastics, or paints. The advantage, as above, is dust-free handling, but pellet disintegration/dispersion in the mixing process.

A particularly attractive new market for agglomerated volcanic ash (unexpanded, expanded, or expanded and crushed) would be as friction-inducing particles for paints or rubber. The agglomerated form would allow the volcanic ash to be introduced into the process in a relatively dust-free manner, in the manufacture of anti-skid paints, athletic and other shoe soles and heels, tires, power transmission belts, crawler-track tread components, and other rubber products.

A further new use for agglomerated volcanic ash is in paints and coatings, to act as friction particles, and impart skid resistance to the coating material.

A further new use for agglomerated volcanic ash, expanded or expanded and crushed, would be as a filler in gypsum products such as, but not limited to, wallboard, joint cements, plasters, and other gypsum-based products.

A new use for relatively dust-free agglomerates, composed of unexpanded, expanded, or expanded and crushed volcanic ash, would be for aggregates, particularly light-weight aggregates. Such materials might be produced using portland cement or other appropriate binder, for incorporation in light-weight concretes, etc.

Other new uses will become evident to those skilled in the art as the production of agglomerated volcanic ash becomes established, and are intended to be within the scope and nature of the present invention.

It is an object of the invention to provide a commercially valuable volcanic ash ore or expanded ore agglomerate in a relatively dust-free form.

It is a further object of the invention to provide a volcanic ash agglomerate that uses expanded or unexpanded volcanic ash ore, which would otherwise not be used for certain applications.

According to one aspect of the invention, expanded and agglomerated volcanic ash may be used for new applications of volcanic ash, such as horticultural and agricultural uses.

According to another aspect of the invention, expanded and agglomerated volcanic ash can be used in aerial reseeding applications.

According to another aspect of the invention, expanded and agglomerated volcanic ash can be used as a thermal and/or acoustical insulator. For certain applications, a fungicide may be incorporated in the agglomerate to retard the growth of molds.

According to another aspect fo the invention, a volcanic ash product, comprised of unexpanded or expanded volcanic ash and a binder or binders is produced. The volcanic ash agglomerates are produced by an agglomeration process. The agglomeration process uses a tumble/agitative agglomeration method, such as a pelletizing disc or granulating drum. The volcanic ash may be formed into a sheet, like paper or cardboard, dried and crushed to form flakes. However, a pressure method, an extrusion method, a pelletizing method, or other agglomeration technology or methods may be used. The volcanic ash agglomerate can be used as a delivery system for seeds, fertilizer, insecticides, herbicides, rodenticides, fungicides, etc., as required, for various horticultural/agricultural markets.

It is an object of the present invention for the tumble/agitative agglomeration technology to comprise tumbling, mixing, granulation, balling, pressing, sheeting or conditioning.

According to another aspect of the invention, the volcanic ash agglomerate comprises expanded or unexpanded volcanic ash and a binder or binders, including but not limited to: liquids, including water, acids, bases, waste liquids, waste liquid/solid mixtures, liquid fertilizers, oils (both vegetable, mineral, natural and refined); sugars; starches; adhesives; polymers; fibers, including cellulose, macerated fabrics, cotton, wool, and polymeric fibers; asphalt; fuller's earth; gypsum; portland cement; lime; clay; bentonite; formaldehyde; alkaline sodium or potassium silicate glasses; and/or a combination of same.

Another aspect of the invention is to use an agglomerated/pelletized volcanic ash product as a seed delivery system that is relatively resistant to wind dispersal or bird or animal consumption.

Another aspect of the invention is to provide an agglomerated volcanic ash product that can be used for loose/cavity fill thermal insulation.

These and other features and advantages of the preferred embodiment of the present invention will become apparent from the detailed description of the invention.

### DETAILED DESCRIPTION OF THE INVENTION

The basis for this invention is the production and use of agglomerated volcanic ash, either crude ash (as it comes from the ground) or after being expanded. In the form of larger agglomerates, whether composed of crude ash or furnace expanded ash, volcanic ash will be saleable in many markets not currently open to existing fine powdery volcanic ash.

Expanded and agglomerated volcanic ash may be used as an additive to soils to absorb moisture, thus increasing the moisture-holding capacity of the soil, reducing the rate of evaporation and enhancing the retention of moisture in the soil making additional water available to plants over an extended period of time. The agglomerated volcanic ash has many of the same qualities as other materials, such as perlite and vermiculite, and can be used for many of the same purposes as those materials.

Expanded or unexpanded volcanic ash is combined with a binder or binders to facilitate the formation of pellets. Numerous additives could be used as binders, including but not limited to, liquids, including water, acids, bases, waste liquids, waste liquid/solid mixtures, liquid fertilizers, oils (both vegetable, mineral, natural and refined); asphalt; sugars; starches; adhesives; polymers; fibers, including cellulose, macerated fabrics, cotton, wool, and polymeric fibers; clay; gypsum; lime; portland cement; bentonite; fuller's earth; formaldehyde; and alkaline sodium or potassium silicate glasses such as sodium silicate.

In a preferred embodiment, expanded or unexpanded volcanic ash is mixed with pulped cellulose, corn starch and water. Mixers such as pin mixers, paddle mixers or other types of mixers can be used. Other materials may also be added to the mixture including, but not limited to, fertilizer, insecticides, herbicides, fungicides, germination enhancers, and/or seeds. When using the agglomerated volcanic ash in a horticultural or agricultural use, it is advantageous to use biodegradable materials in the agglomeration process in order to facilitate the disintegration of the agglomerate and its disbursement into the soil. The mixture is then agglomerated in an agglomeration process, and dried.

The agglomeration performed to create the agglomerated volcanic ash is done by either a tumbling/agitation method, such as a pelletizing disc or granulating drum (possibly best for lower density applications); a pressure method, such as briquetting (possibly best for higher density applications), tableting and/or pressing; an extrusion method; a pelletizing method, such as pelletizing discs; or other agglomeration technology or methods. Agglomerates may range in size from less than ⅛ inch in the largest dimension to one inch or greater. They may be virtually any shape, from spherical, to being star-shape in cross-section.

An example of how the volcanic ash has been agglomerated with pressure technology is described below:

A combination of 40.7% unexpanded volcanic ash ore, 1.65% newsprint (macerated in a blender), 1.65% corn starch and 56% water (added with the paper and starch) is mixed by hand. The mixture is then inserted into a cylinder that is closed on one end. Pressure is applied to the mixture through the use of a rod of slightly smaller diameter than the inside diameter of the cylinder that is inserted into the cylinder. This causes the mixture to compress into a strong volcanic ash agglomerate. The pellets are then dried.

In a preferred embodiment, the volcanic ash agglomerate of the present invention has the following characteristics: relatively dust free; easily handled/transported; rapid and easy cleanup if spilled, waste-free.

Use in Horticultural/Agricultural Applications

Because of the excellent water retention qualities of the expanded volcanic ash agglomerate of the present invention, it can be used in many horticultural or agricultural applications. Expanded agglomerated volcanic ash is similar to or superior in performance to products currently available, such as expanded perlite and vermiculite. As a result, agglomerated volcanic ash can be used to absorb and hold water, reducing the amount of water that must be applied to a plant. Additionally, when combined with fertilizer, insecticides, herbicides, and/or rodenticides, or a seed germination initiator, enhancer, or promoter such as a butenolide, agglomerated volcanic ash can facilitate improved and accelerated growth of plants.

When seeds are included in the mixture of volcanic ash, binders such as cellulose and corn starch, and water, the resulting agglomerate can serve as an optimal aerial seed delivery system. Volcanic ash can provide exceptional aeration and moisture retention qualities that aid in superior plant growth. When a seed or seeds are included in a volcanic ash agglomerate, it is automatically placed in ideal growing conditions. If fertilizer is also included in the volcanic ash agglomerate, the growing conditions become even better. Because the seeds are encased in the volcanic ash agglomerate, there is also less likelihood that the seeds will be eaten by birds or other animals, again increasing the probability of successful seed germination. Additionally, a seed germination initiator, promoter or enhancer such as a butenolide may be incorporated in the agglomerate. The size and weight of the volcanic ash agglomerate provides for more precise placement of the seeds contained therein as well, and ensures that the seed will not be as easily scattered by wind or rain when the agglomerated volcanic ash/seed mixture is used in an aerial reseeding application.

Use in Construction Applications

Expanded, agglomerated volcanic ash possesses qualities similar to currently existing products, such as expanded perlite, that make it suitable for several construction applications. A major use may be as cavity fill thermal insulation. In agglomerated form, the expanded ash would be essentially dust free. Additionally, the incorporation of a fungicide in the agglomerates would inhibit the growth of molds.

The description of the invention above should not be interpreted as limiting the invention to the disclosed embodiment because those who are skilled in the art to which the invention relates will be able to devise other equivalent forms thereof within the scope of the invention. Variations and changes, which are obvious to one skilled in the art, are intended to be within the scope and nature of the present invention. This would include coating agglomerated volcanic ash for certain uses, such as with silicones, silanes, etc., to render the agglomerates water-resistant.

What is claimed is:

1. A volcanic ash product, comprised of agglomerates of one or more of the following: unexpanded volcanic ash, furnace expanded volcanic ash, or furnace expanded and subsequently crushed volcanic ash.

2. The volcanic ash product of claim 1 wherein said agglomerates contain a binding agent or combination of binding agents.

3. The volcanic ash product of claim 2 wherein the binding agent is at least one of the group of water, acids, bases, waste liquids, waste liquid/solid mixtures, liquid fertilizers, oils, sugars, starches, adhesives, polymers, rubber compounds, fibers, cellulose, newsprint, macerated fabrics, cotton, wool, asphalt, polymeric fibers, clay, bentonite, fuller's earth, gypsum, lime, portland cement, formaldehyde; or alkaline silicate glasses of sodium or potassium, such as sodium silicate.

4. The volcanic ash product of claim 1 further comprising grass, tree, shrub, flower, vegetable, crop or other vegetation seed.

5. The volcanic ash product of claim 1 further comprising one or more of the following group: fertilizer; pesticide; insecticide; rodenticide; herbicide; fungicide; or a germination initiator, enhancer or promoter, such as a butenolide.

6. A volcanic ash product, comprised of agglomerated volcanic ash wherein said agglomerated volcanic ash is produced by an agglomeration process using pressure agglomeration technology.

7. The volcanic ash product of claim 6 wherein said pressure agglomeration technology uses a briquetting, tableting or pressing machine, or the formation of sheets to produce flakes.

8. A volcanic ash product, comprised of volcanic ash agglomerates wherein said volcanic ash agglomerates are produced by an agglomeration process using extrusion agglomeration technology.

9. The volcanic ash product of claim 8 wherein said extrusion agglomeration technology uses known equipment to produce agglomerates of various desired configurations.

10. A volcanic ash product, comprised of agglomerated volcanic ash wherein said agglomerated volcanic ash is produced by an agglomeration process using tumble/agitative agglomeration technology.

11. The volcanic ash product of claim 10 wherein said tumble/agitative agglomeration technology uses a granulating drum or pelletizing discs.

12. The volcanic ash product of claim 1 which allows the use of volcanic ash in numerous products in which volcanic ash is not presently used; and for uses and products not now in existence.

13. The volcanic ash product of claim 1 further comprising a coating to enhance performance in certain end uses.

14. The volcanic ash product of claim 13 further comprising a coating which imparts water repellency to said product.
